(19) United States
(12) Patent Application Publication
(10) Pub. No.: US 2012/0252518 A1
(43) Pub. Date: Oct. 4, 2012

(54) NETWORK INITIATED TRIGGERING OF AN OFFLINE DEVICE

(75) Inventors: Dimitrios Karampatsis, Reading (GB); Kamel M. Shaheen, King of Prussia, PA (US); Dorothy Gellert, Mountain View, CA (US)

(73) Assignee: INTERDIGITAL PATENT HOLDINGS, INC., Wilmington, DE (US)

(21) Appl. No.: 13/436,372

(22) Filed: Mar. 30, 2012

Related U.S. Application Data
(60) Provisional application No. 61/471,052, filed on Apr. 1, 2011.

(51) Int. Cl. H04W 4/20; H04W 4/02

(52) U.S. Cl. 455/515

(57) ABSTRACT

A method and apparatus for network initiated attachment are provided. A machine-type communication (MTC) wireless transmit/receive unit (WTRU) is in a detached state. A MTC server sends a trigger request to the MTC WTRU via a network entity, such as a Home Subscriber Server (HSS), a mobility management gateway (MME), a Serving General packet radio service Support Node (SGSN), or a combination thereof. The network entity stores, updates, or obtains information associated with a current, former, or default connection status of the WTRU. The information is obtained from the WTRU attach request message, subscription information, locally stored information, or a combination thereof. The subscription information includes a subscription profile. The WTRU, upon receiving the trigger request, performs a network attachment procedure, enters an attached state and communicates with the MTC server. The WTRU performs a network detach procedure and enters a detached state after completing communications with the MTC server.

### CROSS REFERENCE TO RELATED APPLICATION

This application claims the benefit of U.S. provisional application No. 61/471,052, filed Apr. 1, 2011, the contents of which are hereby incorporated by reference herein.

### FIELD OF INVENTION

This application is related to wireless communications.

### BACKGROUND

A communication device, such as a wireless transmit/receive unit (WTRU), may communicate with a remote device via a communication system. A wireless transmit/receive unit (WTRU) may be configured to perform “machine-type communications” (MTC). MTC communication, which may be referred to as Machine-to-Machine (M2M) communication, may be performed without human interaction. A WTRU configured to perform MTC communication (MTC device) may be associated with a network and may operate in a detached or offline mode.

### SUMMARY

A method and apparatus for network initiated attachment are provided. A wireless transmit/receive unit (WTRU) may be configured to perform machine-type communication (MTC) and may operate in a detached state. A network element or remote device, such as an MTC server, may initiate an attach procedure for the WTRU. The MTC server may send a trigger request message to the MTC WTRU via a network entity, such as a Home Subscriber Server (HSS), a mobility management gateway (MME), a Serving General packet radio service Support Node (SGSN), or a combination thereof. The network entity may store, update, or obtain information associated with a current, former, or default connection status of the WTRU. The information may be obtained from the WTRU attach request message, subscription information, locally stored information, or a combination thereof. The subscription information may include a subscription profile. The WTRU, upon receiving the trigger request message, may perform a network attachment procedure and enter an attached state. The WTRU may then communicate with the MTC server. The WTRU may perform a network detach procedure and enter a detached state after communications with the MTC server are complete. The WTRU may send connection status information to the network element.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 shows an example diagram of a communications architecture for machine-type communication (MTC) device triggering;

FIG. 3 shows an example signal flow for initiating an attach procedure for a MTC device via a Home Subscriber Server (HSS);

FIG. 4 shows an example signal flow for initiating an attach procedure for a MTC device via a HSS with device pre-configuration;

FIG. 5 shows an example signal flow for indicating connection status information for a MTC device;

FIG. 6 shows an example signal flow for initiating an attach procedure for a MTC device via a mobility management gateway; and

FIG. 7 shows an example signal flow for initiating an attach procedure for a MTC device via a Serving General packet radio service Support Node with device pre-configuration.

### DETAILED DESCRIPTION

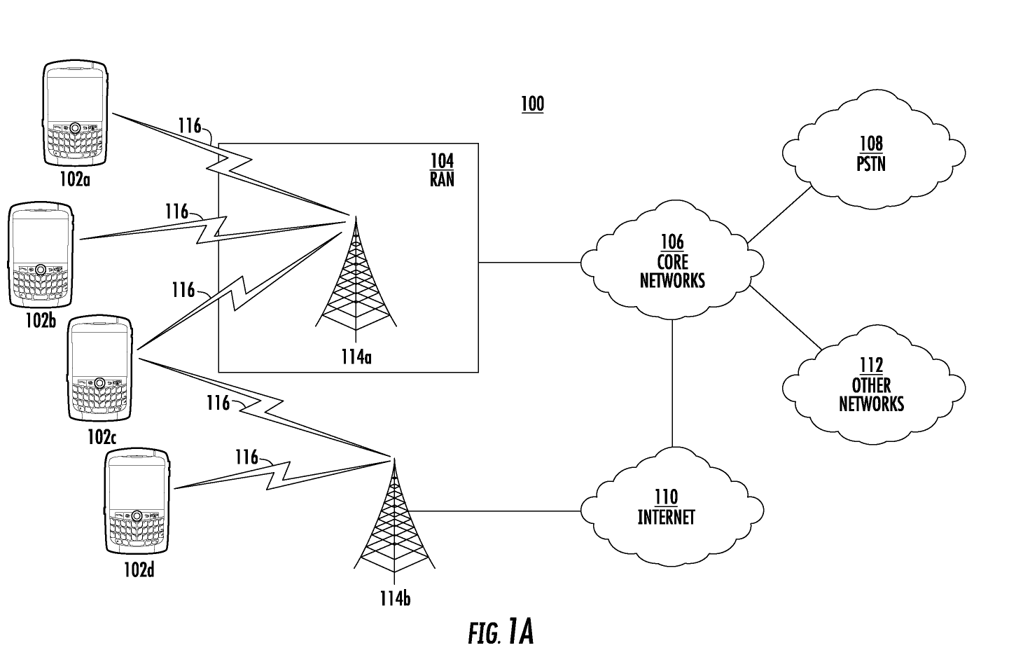

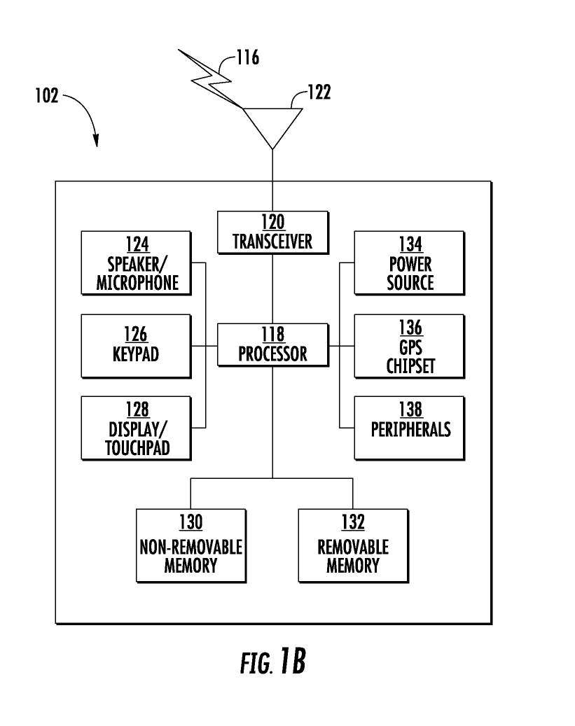

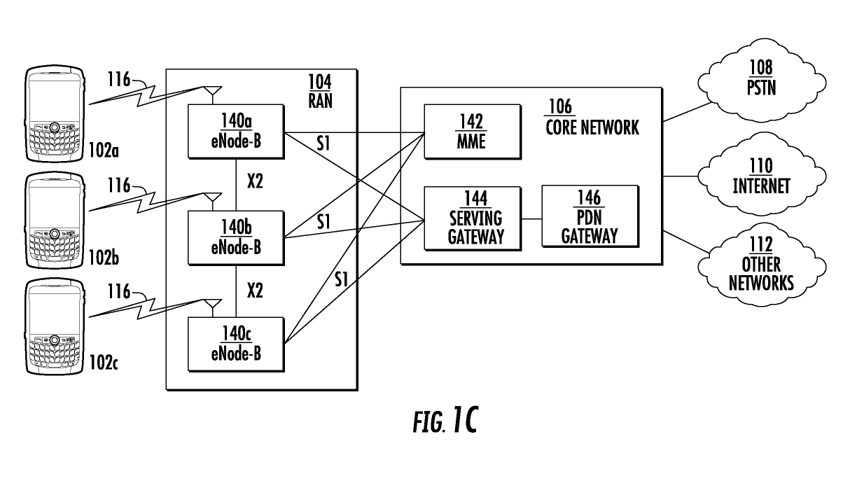

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

Although not shown in FIG. 1C, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

A WTRU, such as the WTRU 102 shown in FIG. 1B, may be configured to perform machine-type communication (MTC) via a network, such as the network shown in FIG. 1C. For simplicity, a WTRU configured to perform MTC communication may be referred to herein as an MTC device. The MTC device may communicate with an entity in the network, such as a server. For simplicity, the network entity may be referred to herein as an MTC server.

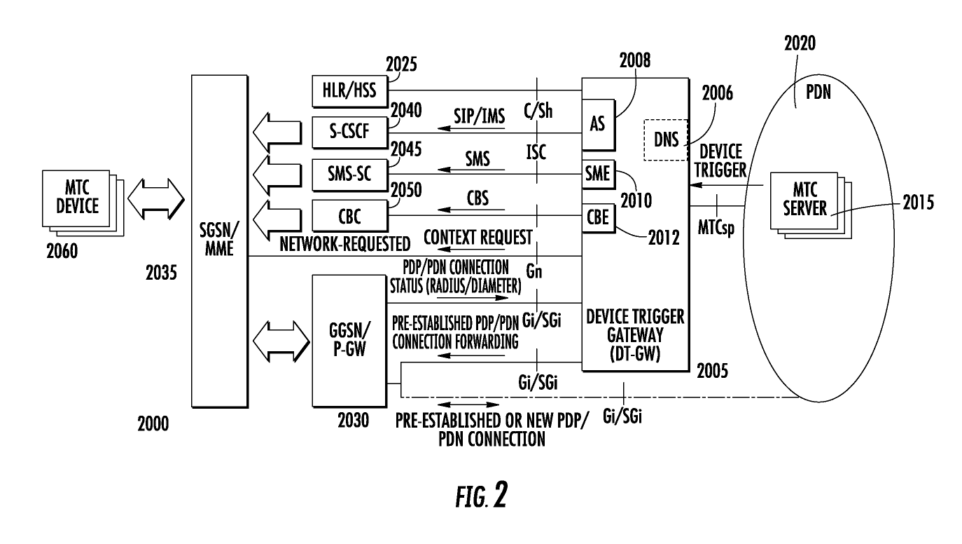

FIG. 2 shows an example MTC device triggering architecture 2000 for MTC device triggering. MTC device triggering may include MTC addressing and Mobile Station Integrated Services Digital Network number (MSISDN)-less communications.

The MTC device triggering architecture 2000 may include a device trigger gateway (DT-GW) 2005, which may be a standalone physical entity or a functional entity. The DT-GW 2005 may include functional entities/mechanisms such as a domain name server 2006, access stratum (AS) 2008, a short message entity 2010 and a cell broadcast entity 2012. The DT-GW 2005 functionality may include the following: ingress of trigger indication messages into a Public Land Mobile Network (PLMN); authorization that the trigger indication is from a trusted MTC server; authorization that the MTC device addressed in a trigger indication is from a MTC server that is authorized to trigger the addressed MTC device; selection of the delivery service and route to forward the trigger indication to for delivery to the MTC device, (e.g. based on collected reachability information and network operator policy); reformatting, as needed, of the trigger indication payload to match the format required for the selected delivery service; egress of trigger indication from the DT-GW to the to the selected delivery service entity for delivery to the MTC device; and appropriate e.g. error handling, error logging and/or error notification when trigger indication is determined to be invalid or unauthorized.

At any given point of time, there is at least one globally routable DT-GW assigned for each subscribed WTRU or MTC device that supports the MTC device trigger feature. A DT-GW 2005 terminates an MTCsp interface for reception of trigger indications from a submitting node, for example, a MTC server 2015 residing in a packet data network (PDN) 2020. The MTC server 2015 may send a trigger indication request to the appropriate DT-GW encapsulated in an IP packet. The trigger indication request could contain pertinent information needed to route the trigger, (e.g. device subscriber identity, trigger command/arguments, relevant device location information, security parameters, and the like).

When a trigger indication is received from a submitting node, the DT-GW 2005 may authorize the received request to make sure it originated from a trusted MTC server and is targeted for a MTC device 2090 for which the MTC server 2015 is authorized to trigger. The DT-GW 2005 may then determine the reachability of the MTC device 2060. To determine “how” reachable the device is, the DT-GW 2005 interrogates a Home Location Register/Home Subscriber Server (HLR/HSS) 2025 using a C and/or Sh interface.

The DT-GW 2005 may use the reachability information obtained from the HLR/HSS 2025, a Gateway General Packet Radio Service (GPRS) Support Node (GGSN)/PDN Gateway (P-GW) Radius/Diameter interface 2030 and mobile network operator (MNO) configured policy information to determine the most efficient and effective service and route to use for forwarding of the trigger indication to be delivered to the MTC device 2060. For example, the DT-GW 2005 may forward the trigger indication to: 1) a GGSN/P-GW 2030 for delivery over an already established PDP context/PDN connection; 2) a Serving GPRS Support Node (SGSN)/Mobility Management Entity (MME) 2035 for delivery over a newly established PDP context (via a Network-Requested PDP Context Activation Procedure initiated by the DT-GW); a Serving Call State Control Function (S-CSCF) 2040 for delivery over a Session Initiation Protocol (SIP)/IP Multimedia Subsystem (IMS) (SIP/IMS) service; a Short Message Service-Service Centre (SMS-SC) 2045 for delivery over SMS; or a Cell Broadcast Centre (CBC) 2050 for broadcast delivery over cell broadcast service (CBS).

An MTC device may operate in a detached or offline mode. For example, an MTC device may be in a packet mobility management (PMM) PMM-DETACHED or evolved packet system (EPS) Mobility Management (EMM) EMM-DEREGISTERED state. An offline MTC device may not be aware of its location. An entity in the network, such as a MME or SGSN, may identify a location of an offline MTC device. The location may be identified on a per Tracking Area or Routing Area identity (ID) granularity, for example when the MTC device is in an IDLE state, such as an EPS connection management (ECM) ECM-IDLE or PMM-IDLE state. The location may be identified on a per cell ID granularity, for example when the device is in a connected state, such as an ECM-CONNECTED or READY/PMM-CONNECTED state.

MTC communication may include Group based optimization, MTC device communication to multiple MTC servers, Internet Protocol version 4 (IPv4) addressing, Small data transmission, including online and offline transmission, such as short message service (SMS) messaging, Low mobility, MTC subscription, MTC device triggering, Time controlled devices, MTC monitoring, Decoupling MTC server from network architecture, MTC identifiers, and Congestion and Overload control.

Congestion and Overload control may include use of a low priority indicator within Access Stratus (AS) and non-access stratus (NAS) signaling to allow an MME or SGSN to reject a connection to low priority devices when congestion and overloading occurs. An MTC device may use an Over the Air (OTA) SIM or Universal SIM, or Open Mobile Alliance (OMA) Device Management (DM).

As stated above, a message, such as a trigger, may be sent via the MTCsp between an MTC server and a device trigger gateway (DT-GW) within a CN. The DT-GW may use reachability, or connection status, information obtained from the HLR/HSS, a GGSN/P-GW Radius/Diameter interface, and MNO configured policy information to determine the most efficient and effective service and route to use for forwarding of the message to be delivered to the MTC device. The DT-GW may reformat and send the trigger indication to a GGSN/P-GW for delivery over a PDP context or PDN connection. The DT-GW may reformat and send the trigger indication to a GGSN for delivery over a PDP context, using, for example, a Network-Requested PDP Context Activation Procedure initiated by the DT-GW. The DT-GW may reformat and send the trigger indication to a S-CSCF for delivery using a SIP or IMS service. The DT-GW may reformat and send the trigger indication to a SMS-SC for delivery via SMS. The DT-GW may reformat and send the trigger indication to a CBC for broadcast delivery over CBS, such as where location information is available in the message request or from another source in order to limit the broadcast area.

However, location information at a network entity, such as a MME or SGSN, for an offline or detached MTC device may be incomplete or inaccurate. For example, the location information may identify a last location of the MTC device before the MTC device went offline and the device may be mobile. The network entity may identify the MTC device as detached if the MTC device is not reachable, if timers expire, or the MTC device detached, such as where the HSS has an un-reachable flag. The network element may not detect that an MTC device is offline.

Described herein are methods and apparatus to trigger devices used for machine-to-machine (M2M) communication that are offline, e.g. detached from the network. The methods allow the CN or the MTC server to be aware when an offline device can be triggered. In an example method, a subscription profile may be added in the HSS/HLR indicating the status of the MTC device. In another example method, the MTC device may indicate its status when attaching or detaching for the network, where status may be saved in a subscription profile. In another example, the MTC server may indicate to a 3GPP network, via the DT-GW, whether the MTC device to be triggered is online or offline.

A subscription profile, which may be maintained at an entity in the network, such as an HSS/HLR, may indicate whether a MTC device is “online” or “offline” by default. The term “by default” may mean that a device is always in an offline or online state. For example, the network operator may indicate in the subscription profile that a particular device is pre-configured to be always offline or online. The default status may be obtained via different methods. In an example, the device itself may indicate its default status. In another example, an operator, such as a mobile network operator (MNO), may always have such devices offline and the HSS may have subscription information that such devices are always offline and also location information that would assist in paging the devices. In another example, the MTC server may indicate to the network operator via the MTCsp interface the status of a device and the location information that would assist in the paging the device.

The subscription profile may be included in a user subscription or MTC device subscription profile. Alternatively, the MTC device may include a parameter, indicating whether the device is offline or online by default, in a message, such as in an Attach Request or Detach Request. In this case, the network entity, which may be an SGSN/MME, may store the default connection state information. The network entity may inform other network entities, such as an HSS/HLR, about the default connection state information for the device. Alternatively, the MTC server may indicate to a CN a connection state of a device, which may include location information, via an interface, such as the MTCsp interface. A network entity in the CN, such as an HSS, may store the connection state information in, for example, a subscription profile.

A subscription profile may be used, for example by a network element such as an HSS, to store device status information, location information, or both, for a detached device. Table 1 shows an example format for subscription data including MTC device status information.

TABLE 1

| Field | Description |
|---|---|
| MTC Device Status or Low | Indicates whether MTC device is online |
| Priority Device Status | “0” or offline “1” by default |
| MTC Device location or Low | Offline device location (Tracking Area Id |
| Priority Device location | or Routing Area Id) |

An MTC device operating in a detached mode may respond to, or be triggered by, a network. For example, an MTC server may trigger an MTC device that is offline, for example detached from the network. The MTC server may send a MTC trigger towards an MTC device or a group of MTC devices, (i.e., for the MTC device(s) to attach to the network), to an entity in a network, such as an HSS/HLR or a MME/SGSN. In the case of the HSS/HLR, the MTC server may send the MTC trigger to the HSS/HLR, for example, via a triggering gateway. The HSS/HLR may update internal information and may send a message to a MME/SGSN indicating the MTC trigger and a status of the MTC device. In the case of the MME/SGSN, the MTC server may send the MTC trigger to the MME/SGSN, for example via a triggering gateway. The MME/SGSN may send a default status request for the device to the HSS/HLR.

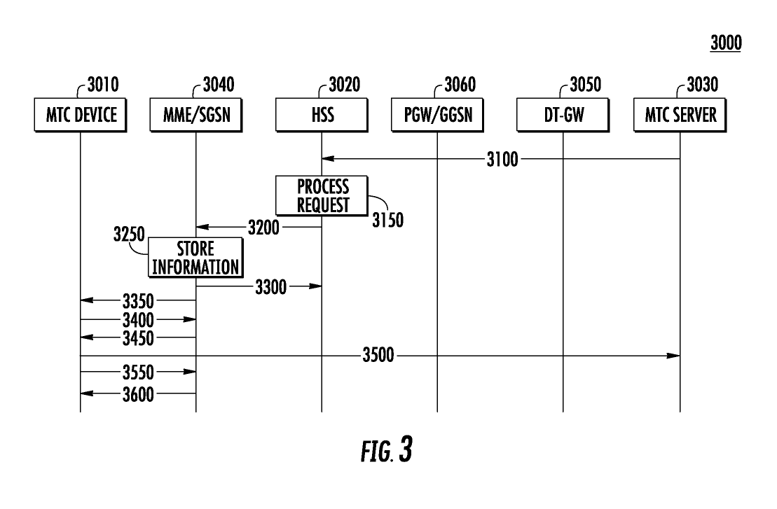

FIG. 3 shows an example signal flow 3000 for triggering a MTC device 3010, (for the MTC device 3010 to attach to the network), via an HSS 3020. The MTC server 3030 may send a MTC trigger to the HSS 3020 (3100). The MTC trigger may indicate a connection status of the MTC device 3010, for example, the MTC trigger may indicate that the MTC device 3010 is offline. The MTC trigger may indicate a location of the detached MTC device 3010. The contents of the MTC trigger or messages derived from the MTC trigger may be referred to as “information” in the context of the signal flow diagrams described herein below, as applicable.

The HSS 3020 may receive the MTC trigger from the MTC server 3030 and may update or store status information for the MTC device 3010 (3150). For example, the HSS 3020 may determine whether connection status information for the MTC device 3010 was previously stored. The HSS 3020 may send at least the MTC trigger to the MME/SGSN 3040 (3200). For example the HSS 3020 may send the MTC trigger received from the MTC server 3030 or the HSS 3020 may generate a message that may include a request to page the detached MTC device 3010, the MTC trigger, MTC device status and/or subscriber data, (which may be referred to as an HSS message).

The MME/SGSN 3040 may receive the MTC trigger or HSS message from the HSS 3020 and may update or store the information associated with the MTC device 3010 (3250). The MME/SGSN 3040 may send an acknowledgement (ACK) message to the HSS 3020 (3300). The MME/SGSN 3040 may then send a paging message to the MTC device 3010 (3350). For example, the MME/SGSN 3040 may send the paging message using the stored location information or using a last known location of the MTC device 3010.

The MTC device 3010 may, in response, send an attach request message to the MME/SGSN 3040 (3400). The MME/SGSN 3040 may, in turn, send an attach accept message to the MTC device 3010 (3450). The MTC device 3010 may establish a connection, such as an IP connection, with the MTC server 3030 (3500). The MTC device 3010 may send data and information to the MTC server 3030.

The MTC device 3010 may enter an offline state after communications with the MTC server 3030 is complete (3550). The MTC device 3010 may send a message including its offline status, such as a Detach Request message, to the MME/SGSN 3040. The MME/SGSN 3040 may send a message, such as a Detach Accept message, to the MTC device 3010 (3600). Although not shown, the network may initiate the detach process for the MTC device 3010, for example, where the MTC device 3010 is in a detached state by default. The network initiated detach procedures may be carried out from, for example, the MME, SGSN or HSS, using methods and techniques known to those of ordinary skill in the art.

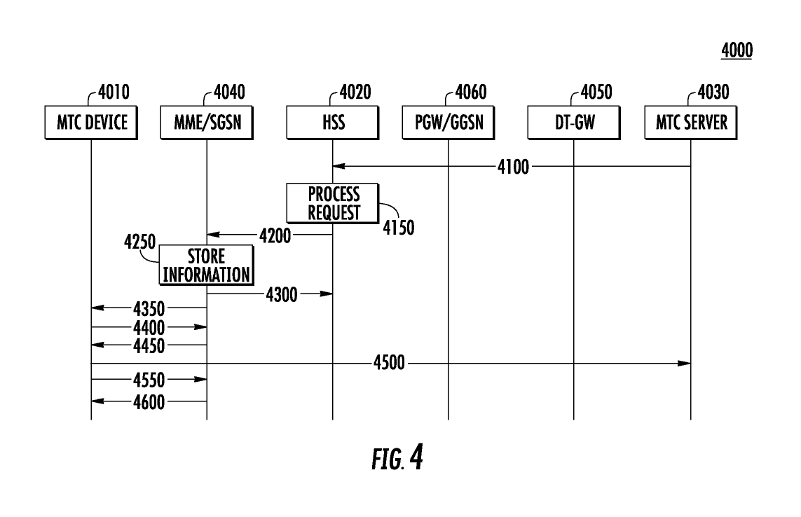

FIG. 4 shows an example signal flow 4000 for triggering a MTC device 4010 via an HSS 4020 with device pre-configuration. The MTC server 4030 may send a MTC trigger to the HSS 4020 (4100). The HSS 4020 may receive the MTC trigger from the MTC server 4030 and may evaluate a subscription profile associated with the MTC device 3010 to determine connection status information for the MTC device 4010 (4150). The HSS 4020 may then send a HSS message to the MME/SGSN 4040 (4200). The HSS message may indicate a request to page the detached MTC device 4010, and may include subscriber data, default connection information, or location information associated with the MTC device 4010.

The MME/SGSN 4040 may receive the HSS message from the HSS 4020 and may update or store information associated with the MTC device 4010 (4250). The MME/SGSN 4040 may then send an ACK message to the HSS 4020 (4300). The MME/SGSN 4040 may send a paging message to the MTC device (4350). For example, the MME/SGSN 4040 may send the paging message using the stored location information or using a last known location of the MTC device 4010.

The MTC device 4010 may, in response, send an attach request message to the MME/SGSN 4040 (4400). The MME/SGSN 4040 may send, in turn, an attach accept message to the MTC device 4010 (4450). The MTC device 4010 may establish a connection, such as an IP connection, with the MTC server 4030 to send data and/or information to the MTC server 4030 (4500).

The MTC device 4010 may enter an offline state after communications with the MTC server 4030 is complete (4550). The MTC device 4010 may send a message including its offline status, such as a Detach Request message, to the MME/SGSN 4040. The MME/SGSN 4040 may send a message, such as a Detach Accept message, to the MTC device 4010 (4600). Although not shown, the network may initiate the detach process for the MTC device 4010, for example, where the MTC device 4010 is in a detached state by default.

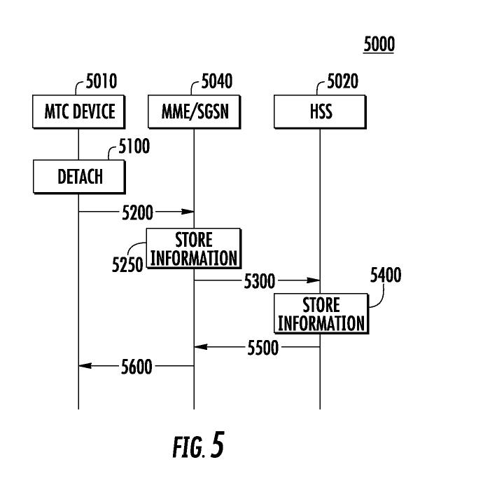

FIG. 5 shows an example signal flow 5000 for indicating connection status information for a MTC device 5010. The MTC device 5010 may enter a detached state (5100). The MTC device 5010 may then send a message, such a Detach Request message, to the MME/SGSN 5040 (5200). The Detach Request message may include connection status information for the MTC device 5010.

The MME/SGSN 5040 may receive the Detach Request message from the MTC device 5010 and may update or store status information associated with the MTC device 5010 (5250). The MME/SGSN 5040 may also send a notification message, such as a Notify Request message, to the HSS 5020 (5300). The notification message may indicate connection status information, (i.e. that MTC device 5010 is offline), location information, or both, for the MTC device 5010.

The HSS 5020 may receive the notification message from the MME/SGSN 5040 and may update or store status information for the MTC device 5010 (5400). This may be stored, for example, is a subscription profile associated with the MTC device based on, for example, the International Mobile Subscriber Identity (IMSI). The HSS 5020 may then send a notification ACK message to the MME/SGSN 5040 (5600). The MME/SGSN 5040 may then send a message, such as a Detach Accept message, to the MTC device 5010 (5700).

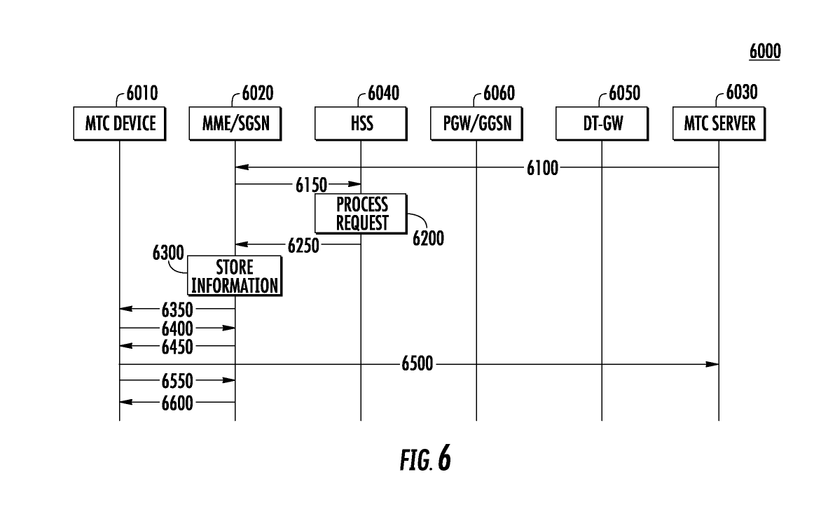

FIG. 6 shows an example signal flow 6000 for triggering a MTC device 6010 via a MME/SGSN 6020. The MTC server 6030 may send a MTC trigger to the MME/SGSN 6020 (6100). The MTC trigger may indicate a connection status of the MTC device 6010, for example, the MTC trigger may indicate that the MTC device 6010 is offline. The MTC trigger may indicate a location of the detached MTC device 6010.

The MME/SGSN 6020 may send a message to the HSS 6040 (6150). The message may include a request for status information for the MTC device 6010. For example, the message may include a request for subscription information. The message may include a status update for the MTC device 6010.

The HSS 6040 may receive the request from the MME/SGSN 6020 and may evaluate a subscription profile associated with the MTC device 7010 to determine connection status information for the MTC device 7010 (6200). The HSS 6040 may update or store status information for the MTC device 6010. For example, the HSS 6040 may determine whether connection status information for the MTC device 6010 was previously stored. The HSS 6040 may send a status report message to the MME/SGSN 6020 (6250). The status report message may indicate connection status information for the MTC device 6010. The status report message may also include subscriber data, location information, or both.

The MME/SGSN 6020 may receive the status report message from the HSS 6040 and may update or store status information associated with the MTC device 6010 (6300). The MME/SGSN 6020 may send a paging message to the MTC device (6350). For example, the MME/SGSN 6020 may send the paging message using the location information or using a last known location of the MTC device 6010.

The MTC device 6010 may, in response, send an attach request message to the MME/SGSN 6020 at 6400. The MME/SGSN 6020 may, in turn, send an attach accept message to the MTC device 6010 (6450). The MTC device 6010 may establish a connection, such as an IP connection, with the MTC server 6030 (6500). The MTC device 6010 may send data and/or information to the MTC server 6030.

The MTC device 6010 may enter an offline state after communications with the MTC server 6030 is complete (6550). The MTC device 6010 may send a message including its offline status, such as a Detach Request message, to the MME/SGSN 6020. The MME/SGSN 6020 may send a message, such as a Detach Accept message, to the MTC device 6010 (6600). Although not shown, the network may initiate the detach process for the MTC device 6010, for example, where the MTC device 6010 is in a detached state by default.

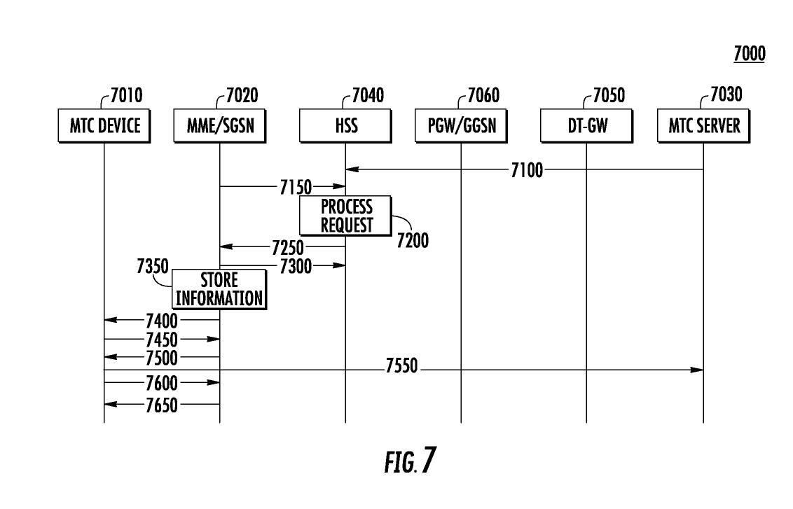

FIG. 7 shows an example signal flow 7000 for triggering a MTC device 7010 via a MME/SGSN 7020 with device pre-configuration. The MTC server 7030 may send a MTC trigger to the MME/SGSN 7020 (7100). The MME/SGSN 7020 may send a message to the HSS 7040 (7150). The message may include a request for status information for the MTC device 7010. For example, the message may include a request for subscription information, connection status information, or both.

The HSS 7040 may receive the request from the MME/SGSN 7020 and may evaluate a subscription profile associated with the MTC device 3010 to determine connection status information for the MTC device 7010 (7200). The HSS 7040 may then send a status report message to the MME/SGSN 7020 (7250). The status report message may indicate connection status information for the MTC device 7010. For example, the HSS 7040 may report that the MTC device 7010 is offline. The status report message may also include subscriber data, location information, or both.

The MME/SGSN 7020 may receive the status report from the HSS 7040 and may send an ACK message to the HSS 7040 (7300). The MME/SGSN 7020 may then update or store status information associated with the MTC device 7010 (7350). The MME/SGSN 7020 may send a paging message to the MTC device 7010 (7400). For example, the MME/SGSN 7020 may send the paging message using the stored location information or using a last known location of the MTC device 7010.

The MTC device 7010 may, in response, send an attach request message to the MME/SGSN 7020 (7450). The MME/SGSN 7020 may send an attach accept message to the MTC device 7010 (7500). The MTC device 7010 may establish a connection, such as an IP connection, with the MTC server 7030 at 7550. The MTC device 7010 may send data and/or information to the MTC server 7030 (7550).

The MTC device 7010 may enter an offline state after communications with the MTC server 7030 is complete (7600). The MTC device 7010 may send a message, such as a Detach Request message, to the MME/SGSN 7020. The MME/SGSN 7020 may send a message, such as a Detach Accept message, to the MTC device 7010 (7650). Although not shown, the network may initiate the detach process for the MTC device 7010, for example, where the MTC device 7010 is in a detached state by default.

Although features and elements are described above in particular combinations, one of ordinary skill in the art will appreciate that each feature or element may be used alone or in combination with any of the other features and elements. In addition, the embodiments described herein may be implemented in a computer program, software, or firmware incorporated in a computer-readable medium for execution by a computer or processor. Examples of computer-readable media include electronic signals, (transmitted over wired or wireless connections), and computer-readable storage media. Examples of computer-readable storage media include, but are not limited to, a read only memory (ROM), a random access memory (RAM), a register, a cache memory, a semiconductor memory device, a magnetic media, (e.g., an internal hard disc or a removable disc), a magneto-optical media, and an optical media such as a compact disc (CD) or a digital versatile disc (DVD). A processor in association with software may be used to implement a radio frequency transceiver for use in a WTRU, UE, terminal, base station, Node-B, eNB, HNB, HeNB, AP, RNC, wireless router or any host computer.

What is claimed is:

1. A method for use in wireless communication, the method comprising:
receiving a machine-type communication (MTC) device triggering message;
determining subscription information for the MTC device, wherein the subscription information includes connection status information associated with the MTC device; and
paging the MTC device.

2. The method of claim 1, wherein the MTC device triggering message includes the connection status information.

3. The method of claim 1, wherein the triggering message includes location information.

4. The method of claim 1, wherein the subscription information is compared against a subscription profile associated with the MTC device.

5. The method of claim 4, wherein a comparison is performed by a second network entity.

6. The method of claim 1, wherein the subscription information is determined from a subscription profile associated with the MTC device.

7. The method of claim 6, wherein a determination is performed by a second network entity.

8. The method of claim 1, wherein the MTC device triggering message is performed on a condition that the MTC device is in a detached state.

9. The method of claim 1, wherein the MTC device triggering message includes default connection status information associated with the MTC device.

10. The method of claim 1, further comprising:
at least one of storing or updating the connection status information in a subscription profile.

11. The method of claim 1, further comprising:
receiving a detached state for the connection status information in a detach request message.

12. A network entity, comprising:
a subscription profile associated with a machine-type communication (MTC) device;
the network entity configured to receive a machine-type communication (MTC) device triggering message;
the network entity configured to determine subscription information for the MTC device, wherein the subscription information includes connection status information associated with the MTC device; and
the network entity configured to page the MTC device.

13. The network entity of claim 12, wherein the subscription information is determined from the subscription profile associated with the MTC device.

14. The network entity of claim 12, wherein the subscription information is compared against the subscription profile associated with the MTC device on a condition that the MTC device triggering message includes the subscription information.

15. A method for use in a wireless transmit/receive unit (WTRU), the method comprising:
transmitting an attachment request in response to a page triggered by a network element on a condition that the WTRU is in a detached state;
entering an attached state;
transmitting data and information to a machine-type communication (MTC) server; and
transmitting detached state status in detach request message.

16. A method for use in wireless communications, the method comprising:
receiving a notification message that a machine-type communication (MTC) device is entering a detached state, wherein the notification message includes MTC device connection status information; and
storing at least the connection status information in a subscription profile associated with the MTC device.

17. The method of claim 16, wherein the notification message includes location information.
